(19) United States
(12) Patent Application Publication
(10) Pub. No.: US 2013/0226719 A1
(43) Pub. Date: Aug. 29, 2013

(54) POINT-OF-SALE SAVING AND INVESTING

(71) Applicant: Harry Powell, Griffin, GA (US)

(72) Inventor: Harry Powell, Griffin, GA (US)

(21) Appl. No.: 13/742,129

(22) Filed: Jan. 15, 2013

Related U.S. Application Data
(63) Continuation-in-part of application No. 13/385,543, filed on Feb. 24, 2012.

(51) Int. Cl. G06Q 40/04; G06Q 20/20

(52) U.S. Cl. CPC G06Q 40/04; G06Q 20/20
USPC 705/17

(57) ABSTRACT

Various implementations of this disclosure provide apparatuses and methods for establishing, acquiring, or purchasing investment products at a POS. In some implementations, a card may be provided to facilitate the investing or saving at the POS. For example, an investment or saving card may be provided that stores information to facilitate the purchase of stock, bonds, CDs, or commodities or to facilitate the opening of a bank account. A POS terminal is configured to facilitate the purchase of stock, bonds, a CD, or commodities or to open a bank account either directly or indirectly.

### CROSS REFERENCE TO RELATED APPLICATION

This application is a continuation-in-part and claims the benefit of U.S. Patent Application Ser. No. 13/385,543, which was filed on Feb. 24, 2012.

### TECHNICAL FIELD

This disclosure relates to investing and saving at a point-of-sale.

### BACKGROUND

There are numerous saving and investing tools including savings accounts, certificates of deposit (CD), checking accounts, bonds, stocks, and commodities (e.g., gold, silver, etc.). However, establishing, acquiring, or purchasing these investment tools can be time consuming and/or overwhelming.

For example, typically to purchase stock, a buyer must open a brokerage account with a brokerage firm, deposit cash into the brokerage account, and then instruct a broker to purchase the stock. A buyer can also purchase stock through an electronic brokerage, which entails opening an online account, depositing cash into the brokerage account, and then purchasing stock online. A buyer also can buy stock directly from a company. This typically entails completing an application online or via regular mail and then purchasing the stock. Purchasing bonds also typically entails opening a brokerage account and purchasing the bonds. Bonds also can be purchased online directly from the U.S. Treasury. Commodities are typically purchased through a broker or through an online trading account.

As another example, opening a bank account (e.g., a savings or checking account) typically entails visiting a bank, online or in-store, and completing an application. Similarly, purchasing a CD typically entails visiting a bank, online or in-store, and purchasing the CD.

Each of these saving and investing resources requires the individual to depart from his/her normal routine to either physically visit a bank or brokerage firm or go to an online site to save and invest. For those individuals whom do not traditionally have relationships with banks or brokerage firms or do not have access to computers, these existing avenues can be a barrier to investing.

### BRIEF DESCRIPTION OF THE DRAWINGS

FIG. 1 illustrates an example environment for saving and/or investing at a point-of-sale.

FIG. 2 illustrates an example method for saving and/ or investing at a point-of-sale.

### DETAILED DESCRIPTION

Various implementations of this disclosure provide apparatuses and methods for establishing, acquiring, or purchasing investment products at a POS. In some implementations, a card may be provided to facilitate the investing or saving at the POS. For example, an investment or saving card may be provided that stores information to facilitate the purchase of stock, bonds, CDs, or commodities or to facilitate the opening of a bank account. A POS terminal is configured to facilitate the purchase of stock, bonds, a CD, or commodities or to open a bank account either directly or indirectly.

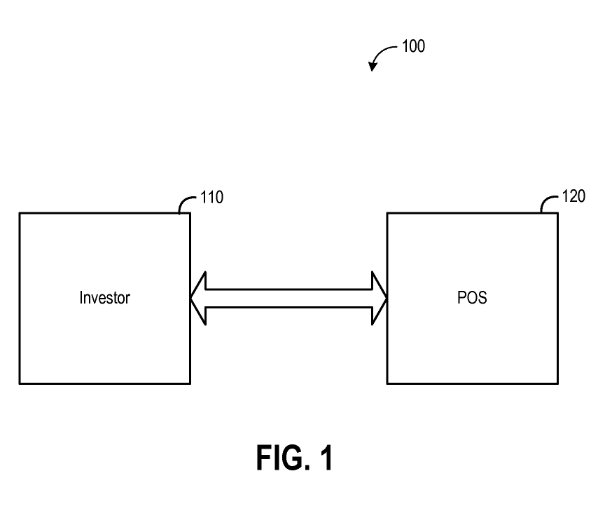

FIG. 1 illustrates an example environment 100 for saving and/or investing at a point-of-sale. A prospective investor 110 while at a POS 120 may establish, acquire, or purchase a saving or investing product such as a savings account, CD, checking account, bonds, stocks, and commodities. In some implementations, the POS 120 may be any physical checkout location where money is exchanged for goods or service. The physical checkout may be in a grocery store, convenience store, mass retailer, restaurant, hotel, salon, gas station, or any other retail business or tore. In some implementations, the POS 120 may be a standalone station such as a kiosk in a retail store or any other location.

For example, in some implementations, a prospective investor 110 while at a POS 120 can inform a cashier of the investor's desire to purchase stock of a particular company. The cashier initiates the stock purchase by entering information in a POS terminal to carry out the purchase (e.g., company name, number of shares, information identifying the investor). The POS terminal may be configured to purchase stock, for example, such as an online broker. In some implementations, the POS terminal may interface with an online broker that is configured to purchase stock.

In some implementations, the investor can inform the cashier orally of the company name and number of shares desired to be purchased. In some implementations, the investor can provide the cashier or the POS terminal with a card that indicates the name of the company of which the investor desires to purchase stock. The investor may retrieve the card from a stand that houses cards corresponding to different companies. In some implementations, the cards may store stock information (e.g., stock symbol) of the company so that when the investor gives the card to the cashier, the cashier may swipe the card to extract the information to purchase the stock. In some implementations, the cards may represent different denominations of stocks. In this way, the investor or cashier may swipe the card to extract the number of stocks desired to be purchased as well other information to purchase the stock. In some implementations, the stand may include electronic information on stock prices (e.g., stock market tickers) to help the investor decides which company and the denomination of stock to purchase.

In some implementations, the cashier may swipe the investor's driver's license to extract embedded information that identifies the investor.

In some implementations, once the stock has been purchased, the POS terminal can print out a stock certificate or issue a card that includes all the stock information.

In this way, an investor may purchase stock during his normal routine of shopping. POS terminals configured to sell stock may make investing accessible to many prospective investors that do not invest utilizing the existing investing avenues.

In some implementations, the POS may be a self check-out POS. In this case, the investor may enter the information in the POS terminal as discussed above.

An investor may purchase bonds in a similar manner as discussed above.

In some implementations, an investor may sell stock, for example, at a POS. For example, the investor may present a stock certificate to the cashier or POS terminal and then receive the funds from the sale of the stock. In some implementation, the investor may present the stock certificate printout or card discussed above which may include coded information that may be scanned to facilitate issuing any funds from the sale of the stock. The POS terminal may be configured to sell stock, for example, such as an online broker. In some implementations, the POS terminal may interface with an online broker that is configured to sell stock.

In some implementations, an investor may transfer stock, for example, at a POS. For example, an investor may want to make a gift of stock. In some implementations, the investor can make a gift of stock by purchasing the stock as described above and then transferring the stock to the person to whom the investor desires to give the stock. The POS terminal may be configured to transfer stock. In some implementations, the investor may receive a gift card to provide to the recipient of the stock. In some implementations, the recipient may take the gift card to a POS terminal configured to issue stock certificates to receive the stock certificates corresponding to the gift card.

In some implementations, an investor may receive dividends at a POS. For example, the investor may present a stock certificate to the cashier or POS terminal and then receive any dividends issued for the stock. In some implementation, the investor may present the stock certificate printout, card, or gift card discussed above which may include coded information that may be scanned to facilitate issuing the dividend.

As another example, in some implementations, a prospective investor 110 while at a POS 120 can inform a cashier of the investor's desire to purchase a CD. For example, in some implementations, a prospective investor 110 while at a POS 120 can inform a cashier of the investor's desire to purchase a CD from a particular bank. The cashier may initiate the CD purchase by entering into a POS terminal information to carry out the purchase. The POS terminal may be configured to purchase CDs or interface with another system that is configured to purchase CDs.

In some implementations, the investor can inform the cashier orally of the details (i.e., bank, dollar amount) of the CD that the investor would like to purchase. In some implementations, the investor can provide the cashier or POS terminal with a card that indicates the bank from which the investor desires to purchase a CD. The investor may retrieve the card from a stand that houses a plurality of cards corresponding to different banks. In some implementations, the cards may store information of the bank so that when the investor gives the card to the cashier, the cashier may swipe the card to extract information to purchase the CD. In some implementations, the cards may represent different values of the deposit amount for the CDs. In this way, the investor or cashier may swipe the card to extract the value desired to be purchased as well other information to purchase the CD.

Once the CD has been purchased, the POS terminal can print out a certificate or issue a card. In this way, a convenient avenue is provided for conveniently converting cash into an investment.

As another example, in some implementations, a prospective investor 110 while at a POS 120 can inform a cashier of the investor's desire to open a bank account.

For example, in some implementations, a prospective investor 110 while at a POS 120 can inform a cashier of the investor's desire to open a bank account with a particular bank. The cashier may initiate opening the bank account by entering into a POS terminal information to carry out the transaction. The POS terminal may be configured to open bank accounts or interface with another system that is configured to open bank accounts.

In some implementations, the investor can inform the cashier orally of the details of the bank account (e.g., bank, type of account) that the investor would like to open. In some implementations, the investor can provide the cashier with a card that indicates the bank with which the investor desires to open a bank account. The investor may retrieve the card from a stand that houses a plurality of cards corresponding to different banks. In some implementations, the cards may store information of the bank so that when the investor hands the card to the cashier, the cashier may swipe the card to extract information to open the account. In some implementations, the cards may represent different types of accounts. In this way, the investor or cashier may swipe the card to extract the information to open the account.

Once the account has been opened, the POS terminal can print out any account details (e.g., account number) or issue a card. In this way, a convenient avenue is provided for opening a bank account.

In some implementations, once the bank account is opened, the account holder can deposit money into the bank account at the POS. For example, the account holder may provide his account information to the cashier or POS terminal and then deposit funds into the account. In some implementation, the account holder may present the printout or card discussed above which may include coded information that may be scanned to facilitate depositing funds into the bank account.

As another example, in some implementations, a prospective investor 110 while at a POS 120 can inform a cashier of the investor's desire to purchase a commodity such as a precious metal. For example, in some implementations, a prospective investor 110 while at a POS 120 can inform a cashier of the investor's desire to purchase a particular type of commodity. The cashier may initiate the purchase by entering into a POS terminal information to carry out the purchase. The POS terminal may be configured to purchase commodities or interface with another system that is configured to purchase commodities.

In some implementations, the investor can inform the cashier orally of the details of the commodity the investor would like to purchase. In some implementations, the investor can provide the cashier with a card that indicates the commodity the investor desires to purchase. In some implementations, the investor may retrieve the card from a stand that houses a plurality of cards corresponding to different commodities. In some implementations, the cards may store information regarding the commodity so that when the investor hands the card to the cashier, the cashier may swipe the card to extract information to purchase the commodity. In some implementations, the cards may represent different values of the commodity. In this way, the investor or cashier may swipe the card to extract the value desired to be purchased as well other information to purchase the commodity.

Once the commodity has been purchased, the POS terminal can print out a receipt of the transaction or issue a card. In some implementations, if the commodity is a precious metal, for example, the system can arrange to mail the commodity to an address provided by the investor at the POS. In some implementations, after the commodity has been purchased at the POS, the investor thereafter may go online to arrange for delivery of the commodity. In this way, a convenient avenue is provided for purchasing commodities.

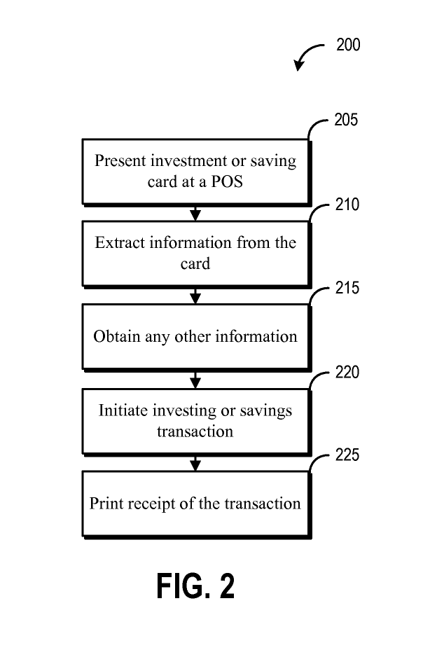

FIG. 2 illustrates a method for saving and/or investing at a point-of-sale.

At stage 205, a prospective investor presents an investment or saving card at a POS. For example, the investment or saving card may be a card storing information to facilitate the purchase of stock, bonds, a CD, or commodities or to open a bank account.

At stage 210, information is extracted from the card to facilitate the investing or saving. In some implementations, this can be achieved by swiping or scanning the card at a POS terminal.

At stage 215, any other information is obtained that may be needed to complete the transaction. In some implementations, the investor's driver's license may be used to extract additional information.

At stage 220, the investing or savings transaction is initiated. In some implementation, the POS terminal is configured to facilitate the purchase of stock, bonds, a CD, or commodities or to open a bank account either directly or indirectly.

At stage 225, a receipt of the transaction is printed. In some implementations, the receipt may include a stock certificate, a certificate, or an agreement reflecting terms. In some implementations, the receipt may include an account number. In some implementations, the receipt may be in the form of a card with information encoded on the card.

Implementations of the device of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, Standard interchange language (SIL), Component Object Model (COM) enabled programming languages, or other instructions stored in a computer readable medium including existing and future developed instructions specific to POS terminals and online brokers.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, implementations of the subject matter described in this specification can be operable to interface with a computing device that is integrated with or connected to (directly or indirectly) a display, e.g., a CRT (cathode ray tube) or LCD (liquid crystal display) monitor, for displaying information to the user. To provide for input by a user to the computer, implementations of the subject matter described in this specification further can be operable to interface with a keyboard, a pointing device (e.g., a mouse or a trackball), scanner, a barcode reader, magnetic strip reader, or any other input device.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described program components and systems can generally be integrated together in a single software product or packaged into multiple software products.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Reference throughout this specification to “an embodiment” or “implementation” or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A computer-implemented method for investing at a point-of-sale, the method comprising:
extracting information from a card at a point-of-sale wherein the card stores investing information for an investment product;
receiving funds for the purchase of the investment product at the point-of-sale; and
generating a receipt of the purchase.

2. The method of claim 1 further comprising:
purchasing the investment product at the point-of-sale.

3. The method of claim 1 further comprising:
selling the investment product at a point-of-sale.

4. The method of claim 1 further comprising:
transferring the investment product at a point-of-sale.

5. The method of claim 1 further comprising:
determining a dividend amount for the investment product at a point-of-sale wherein determining the dividend amount comprises extracting information from the receipt.

6. The method of claim 1 wherein the investment product is stock and the investing information stored on the card includes company information of a company from which stock is desired to be purchased.

7. The method of claim 6 wherein the investing information stored on the card further includes a denomination of stock to be purchased.

8. The method of claim 1 wherein the investment product is a bond.

9. The method of claim 1 wherein the investment product is a CD and the investing information stored on the card includes bank information of a bank from which a CD is desired to be purchased.

10. The method of claim 9 wherein the investing information stored on the card further includes the deposit amount for the CD to be purchased.

11. The method of claim 1 wherein the investment product is a commodity.

12. A computer-implemented method for opening a bank account at a point-of-sale, the method comprising:
extracting information from a card at a point-of-sale terminal wherein the card stores banking information for a bank account to be opened; and
generating a receipt indicating bank account details of the bank account.

13. The method of claim 14 further comprising:
opening the bank account at the point-of-sale terminal.

14. The method of claim 14 further comprising:
receiving funds at the point-of-sale terminal and depositing the funds in the bank account.

15. A investment stand comprising:
a rack to hold a plurality of cards wherein each card corresponds to at least one investment product and each card includes investment information stored on the card.

16. The investment stand of claim 15 wherein the at least one investment product is stock and the investing information stored on each card includes company information of a company from which stock is desired to be purchased.

17. The investment stand of claim 15 wherein the at least one investment product is a bond.

18. The investment stand of claim 15 wherein the at least one investment product is a CD and the investing information stored on each card includes bank information of a bank from which a CD is desired to be purchased.

19. The investment stand of claim 18 further comprising a display configured to display stock prices.

20. The investment stand of claim 17 further comprising a point-of-sale terminal configured to initiate an investment based on the plurality of cards.
